(19) United States
(12) Patent Application Publication
(10) Pub. No.: US 2010/0175827 A1
(43) Pub. Date: Jul. 15, 2010

(54) METHOD AND DEVICE FOR FUSING PLASTIC PROFILE BARS, STOP AND HEAT REFLECTOR FOR SUCH A DEVICE

(75) Inventors: Bernhard Eisenbach, Brechen (DE); Guido Schmittinger, Hahn (DE); Thorsten Schwörendt, Waltenhofen (DE)

Correspondence Address: CONNOLLY BOVE LODGE & HUTZ, LLP, P O BOX 2207, WILMINGTON, DE, 19899, US

(73) Assignee: ROTOX BESITZ - UND VERWALTUNGSGESELLSCHAFT MBH, Brechen (DE)

(21) Appl. No.: 12/676,977

(22) PCT Filed: Sep. 9, 2008
(86) PCT No.: PCT/EP2008/007355

§ 371 Date: Mar. 8, 2010

(30) Foreign Application Priority Data
Sep. 11, 2007 (DE) 10 2007 043 195.5

(51) Int. Cl. B29C 65/02

(52) U.S. Cl. 156/322; 156/391

(57) ABSTRACT

A method and a device for fusing plastic profile bars (4, 6), such as those comprising frames for windows or doors, includes a stop (12) and a heat reflector (16) for such a device. At least one of the profile bars (4, 6) already has inserted therein a gasket or seal. Material from the profile bar or bars is displaced in the region of the at least one seal (4.1, 6.1) before or while the profile bars (4, 6) to be fused or welded are pressed against one another. The material from the profile bar or bars is displaced with at least one displacement element (14, 24, 34), which may be separate from or associated with the heat reflector.

### CROSS-REFERENCE TO RELATED APPLICATIONS

This application is a national stage application (under 35 U.S.C. §371) of PCT/EP2008/007355, filed Sep. 9, 2008, which claims benefit of German application 10 20007 043 195.5, filed Sep. 11, 2007.

### TECHNICAL FIELD

The invention relates to a method and to a device for welding plastic profile bars, to a stop and to a heat reflector or heating mirror for such a device. The invention is used particularly for the production of frames for windows or doors, whereby two plastic profile bars are provided, one of them having at least one gasket and at least one of them being heated up by a heating device on the surfaces that are to be fused or welded, after which the profile bars are then pressed against each other in order to create a connection. As far as the device is concerned, at least one clamping device is provided to clamp the profile bars and at least one heating device is provided to heat up at least one of the profile bar surfaces that is to be welded.

### BACKGROUND AND STATE OF THE ART

German patent specification DE 36 41 019 C2 discloses a device for welding plastic profiles to form frames of windows or doors using two welding units whose distance to each other can be adjusted. Each welding unit has clamping devices for clamping the profile bars whose joining surfaces are to be welded together, a stop that can be moved between the clamping devices in order to position the profile bars, and a welding mirror, which can likewise be placed between the ends of the plastic profiles that are to be joined together in order to heat the joining surfaces prior to their being pressed together.

For several years now, the plastic profile bars used to produce window or door frames are delivered by the profile manufacturers with gaskets that have already been inserted into or extruded onto the profiles in order to hold the glass and/or in order to seal the door-frame connection. When the profile bars are welded or joined together, first of all, the frame pieces made of thermoplastic material are heated up by means of a heat reflector or heating mirror to a temperature above the melting temperature, and then they are pressed against each other until the profile bars have cooled off and a permanent connection is established. Pressing the parts against each other causes the plastically deformable plastic to spill over in the welding area, forming a weld bead or weld seam. This weld seam is subsequently ablated (polished).

However, problems occur in the area of the inserted or extruded gaskets, because, on the one hand, the gaskets can spill over due to accumulations of the material, which can have a detrimental effect on the sealing function since it is not possible to attain a uniform contact over the entire length of the frame, but rather only punctual contact in the area of the weld seam. This is also detrimental to the proper fit of the window or door frame, resulting in leaks and stiffness of movement.

On the other hand, the accumulations of material in the area of the gaskets, which are mostly installed with a positive or non-positive fit, are difficult to cut off with a blade or to remove with a milling tool in the conventional manner.

In order to eliminate or prevent accumulations of material, it is a known procedure in the state of the art to ablate material at the ends of the profile bars that are to be welded before the welding procedure. In order to do so, according to a known method, a specially contoured milling tool is employed that ablates material from the plastic profile in the area of the gaskets. A problematic aspect in this context, however, is that the profiles at first have quite high tolerances, so that an automatic milling procedure is very difficult. Especially if the profile deviates from the specifications, but even in the case of true-to-dimension profiles, the milling tool can damage the gasket so that the sealing properties are no longer ensured. It is likewise problematic with this method that it calls for an additional work step, which prolongs the cycle time, in other words, the production time of the window frames. This makes the window frames altogether more expensive.

Another familiar approach provides for the removal of the accumulations of material after the welding procedure. This can be done either manually with handheld tools or else using special automatic corner cleaners. Manual processing, however, is very laborious and calls for additional personnel, which makes the frames considerably more expensive. The automatic corner cleaners are only able to process the area of the gaskets to a limited extent, in addition to which they can also damage the gaskets since the corner cleaners have to reach under the gaskets.

A last method known from the state of the art provides for the use of stamps to reshape the gaskets in the automatic welding machine and the plastic material of the profile bars. The stamps exert pressure on the gaskets that can be plastically deformed when they are heated by means of the welding mirror, thereby reshaping them. This, however, is technically complex and requires a laborious retooling of the automatic welding machines. Moreover, the function of the gasket is detrimentally affected since, on the one hand, the surface properties of the gaskets change in that area and, on the other hand, the gaskets acquire a different, more or less random profile. In addition to this, the plastic material cannot be completely shaped back to its original form by means of the stamp.

### SUMMARY OF THE INVENTION

Therefore, an objective of the invention is to put forward a method and a device for welding plastic profile bars, a stop as well as a heat reflector or heating mirror for such a device, so as to overcome the drawbacks of the state of the art and especially so as to attain as close as possible to a flawless connection between two plastic profile bars with an already inserted gasket, whereby the gasket is not damaged or detrimentally affected in terms of its function.

One method according to the invention for welding plastic profile bars, which is employed for the above-mentioned plastic profile bars, some of which have already been fitted with gaskets, provides for material of the profile bar(s) in the area of at least one gasket to be displaced prior to or during the heating step or prior to the time when the surfaces of the plastic profile bars that are to be fused or welded are pressed together.

This has the advantage that, on the one hand, the gasket is not damaged and that, on the other hand, when the profile bars are pressed or joined together, plastic material can no longer spill over in the area of the gaskets in a manner that would detrimentally affect the function of the gaskets. Unlike the methods known from the state of the art, which provide for ablation using milling tools or the like, now the gasket is protected and, at the same time, it is avoided that the profiles require laborious reworking or that they can no longer be reworked because the profile structure in the joining area has been damaged to such an extent that the gaskets are no longer neatly held in place.

In one embodiment, the method is executed prior to or during the heating step or prior to the time when the ends that are to be welded are pressed together—which is carried out directly in a welding device by means of which the method is executed. This implementation allows the cycle times for the production of the door or window frames to remain virtually unchanged.

The term “displacement” as set forth in the application especially refers to the fact that the material of the profile bar(s) is shifted but remains joined in one piece to the profile bar(s). In particular, this is equivalent to a deformation of the profile bar(s).

According to a first advantageous embodiment, it is provided that the material of the profile bar(s) is displaced mechanically. A mechanical displacement can be achieved especially easily by means of appropriate displacement elements.

In this context, it is also advantageous for the displaced material of the profile bar(s) to be partially melted prior to the displacement. This reduces the forces needed for the displacement and allows a particularly neat and defined displacement of plastic material.

Preferably, the material is displaced at a height and depth between 1 mm and 25 mm, especially between 1 mm and 6 mm, and at a length of 8 mm to 15 mm. This displaced volume is sufficient to prevent accumulations of plastic from spilling over during the joining procedure, something which could detrimentally affect the function of the gaskets.

It is especially advantageous for the material to be displaced in accordance with a prescribed profile. A displacement with a defined profile generates defined setbacks whose properties can be predicted with great accuracy, so that it is then possible to manufacture windows or doors that function particularly well.

It is especially preferred for the profile to be shaped like a cube, like a cam, like a wedge or a double wedge, or like a comb. These profiles make it possible to ensure especially neat material displacement.

Another variation provides for a device for fusing or welding plastic profile bars, at least one of which has a gasket. The device is fitted with at least one clamping device for clamping the profile bars and with at least one stop for aligning the profile bars in the device, and it also has at least one heating device for heating up at least one of the surfaces of the profile bars that is to be welded. At least one displacement element that is arranged on the stop and/or that is arranged on the heating device and/or that can be placed into a space formed by the profile bars that are to be welded is provided in the area of the at least one gasket of the profile bars for purposes of displacing material of the profile bar(s).

The device according to the invention achieves the same advantages as the method according to the invention.

A preferred embodiment of the invention provides that the displacement elements are configured as pressure pieces located on the stop and/or on the heating device. Such displacement elements are easy to position with respect to the profile bars, thus allowing especially simple and precise processing.

Advantageously, the displacement element(s) can be moved, quickly replaced and/or plugged in, whereby preferably several plug-in positions are provided. This allows for adaptation to various profile types having different geometries and different positions of the gaskets.

Especially preferably, the stop and/or the heating device can be exchanged and/or quickly replaced, either manually and/or automatically. The stops and the heating device are, for one thing, wearing parts, whereby the displacement elements are subjected to considerable loads, so that they have to be replaced or serviced from time to time. In order not to have to shut down the operation of the device any longer than absolutely necessary, it should be possible to replace the stops and/or the heating devices very quickly. Moreover, this allows for different stops and/or heating devices to be provided whose displacement elements are installed in different positions, so that it is particularly easy to make an adaptation to different profiles.

Another embodiment of the invention provides for the displacement element(s) to be shaped like a cube, like a cam, like a wedge or a double wedge, or like a comb. Such geometries account for very well-defined material displacement.

An alternative preferred embodiment provides that the displacement element is configured as a separate element. A separate element can be employed in a very flexible manner.

Advantageously, the separate displacement element can be moved by means of a positioning device. This positioning device allows a very simple movement of the displacement element, especially when the positioning device is motor-driven.

If the positioning device can be moved parallel to a plane formed by a given joining surface of the profiles, this entails the additional advantage that a single displacement element can be used to process several gaskets.

It is particularly advantageous if the displacement element can be heated. In this case, the plastic material can be partially melted during the displacement and the force needed to process the plastic material is reduced.

Another preferred embodiment of the displacement element provides that a positioning stop is associated with the displacement element, said positioning stop allowing automatic positioning of the displacement element on the profile bars. Consequently, complicated controlling of the displacement element is superfluous; it is sufficient for the displacement element to be activated as soon as the profile bars have been properly aligned, and the advancing movement of the positioning device of the displacement element is switched off as soon as the positioning stop touches the plastic profile.

The heating device is preferably configured as a heat reflector or heating mirror.

Another advantage arises if displacement elements are provided in each case on a stop and/or on a separate displacement element and on a heat reflector or heating mirror. As a rule, the window or door frames are fitted with several gaskets that are distributed over the cross section of the profile. The distribution of several displacement elements on the stop, on the heat reflector or heating mirror and/or on the separate displacement element makes it possible to process several gaskets at the same time.

Moreover, in a particularly advantageous manner, it is provided that the stop, the heating device and/or the separate displacement element have a non-stick coating. In this way, profile material that has melted or that is to be displaced is prevented from adhering to the individual components. Furthermore, this makes it possible to create smoother profile surfaces.

Another embodiment of the invention provides that the heating device and/or the stop can be moved. Preferably, this movement can be made in a plane defined by the profile surface to be welded. As a result, different profile cross sections having the gaskets in different positions can be processed with the same device.

Another preferred embodiment provides for multi-component, preferably two-component, heating devices and/or stops whose parts can be moved with respect to each other. In this context, the displacement elements are arranged on different parts. This increases the range of use of the device since the heating device and/or the stop can be adapted very readily to different profiles.

According to a refinement of the invention, it is provided that the displacement element(s) provided on the stop and/or the separate displacement elements is/are heated, so that the material displacement on the profiles can be carried out by means of plastic deformation.

The heating preferably reaches a temperature above 180° C. [356° F.], preferably above 210° C. [410F ° F.] and below 280° C. [536° F.], especially preferably about 230° C. [446° F.].

Another variation of the invention provides for a heating device for heating up surfaces of plastic profile bars that are to be fused or welded, one of which has at least one gasket, whereby at least one displacement element is provided on the heating device for purposes of displacing material of the profile bar(s) in the area of the at least one gasket.

Such a heating device can also be retrofitted into existing welding devices and, with just a few adaptations of the control, allows the method according to the invention to be carried out on existing welding devices.

In this context, the heating device is preferably configured as a heat reflector or heating mirror. Heat reflectors or heating mirrors have proven their worth for heating up plastic profile bars that are to be welded together.

Advantageously, the displacement element(s) is/are configured as pressure pieces on the heating device. It is very easy to implement the pressure pieces on the heating device.

Furthermore, it is advantageously provided that the displacement element(s) can be moved, quickly replaced and/or plugged in, and/or that several plug-in positions are provided for the displacement elements. In this manner, the heating element can be adapted to different profiles in a particularly flexible way.

Another advantage is achieved if the heating device can be exchanged and/or quickly replaced, either manually and/or automatically. This avoids delays in the processing, and the largest possible number of different profile cross sections can be processed.

Shapes that are like a cube, like a cam, like a wedge or a double wedge, or like a comb have proven to be suitable geometries for the displacement element(s). Such geometries make it possible to achieve a defined displacement.

If the heating device and/or the displacement elements have a non-stick coating, profile material can be prevented from adhering during the heating and the displacement.

According to a refinement, the heating device can preferably be moved, especially in a plane formed by the appertaining joining plane of the profile surfaces that are to be welded. In this manner, the heating device can be used for several different profiles.

Another preferred embodiment provides for multi-component, preferably two-component, heating devices whose parts can be moved with respect to each other. In this context, the displacement elements are arranged on different parts. This increases the range of use of the device since the heating device can be adapted very readily to different profiles.

Another independent idea of the invention provides for a stop for positioning plastic profile bars, one of which has at least one gasket, particularly for the production of frames for windows or doors, whereby at least one displacement element is provided on the stop for purposes of displacing material of the profile bar(s) in the area of the one gasket. This allows the above-mentioned advantages to be achieved.

Advantageously, the displacement element(s) is/are configured as a pressure piece on the stop. Pressure pieces have proven to be particularly functional.

Especially preferably, displacement elements are employed that can be moved, quickly replaced and/or plugged in, and/or are provided for the multiple plug-in positions. This increases the flexibility of the stop according to the invention.

Another advantage is achieved when the stop can be exchanged and/or quickly replaced, either manually and/or automatically. This avoids delays when numerous window profiles are being processed.

Shapes that are like a cube, like a cam, like a wedge or a double wedge, or like a comb have proven to be especially suitable geometries, all of which allow material to be displaced particularly well.

Preferably, the displacement element has a non-stick coating so that no profile material adheres to the displacement element.

Another embodiment of the invention provides that the stop can be moved. The movement can preferably be made in a plane defined by the profile surface to be welded. As a result, different profile cross sections having the gaskets at different positions can be processed with the same device.

Another preferred embodiment provides for multi-component, preferably two-component, stops whose parts can be moved with respect to each other. In this context, the displacement elements are arranged on different parts. This increases the range of use of the device since the stop can be adapted very readily to different profiles.

If the displacement element continues to be heated separately, it is possible to achieve a very simple and defined material displacement by means of plastic deformation of the profiles.

### DESCRIPTION OF THE DRAWINGS

Additional objectives, advantages, features and application possibilities of the present invention can be gleaned from the description below of an embodiment making reference to the drawings. In this context, all of the features described and/or presented in the form of images constitute the subject matter of the present invention, be it individually or in a meaningful combination, also independently of their compilation in the claims or in the claims to which they refer back.

The following is shown:

FIG. 1A—a perspective schematic view of a section of a device according to the invention, in accordance with a first embodiment during the alignment of plastic profile surfaces;

FIG. 1B—an enlargement of part of FIG. 1A;

FIG. 2A—a perspective schematic view of the device from FIG. 1A after the alignment;

FIG. 2B—an enlargement of part of FIG. 2B;

FIG. 3A—a perspective schematic view of a section of a device according to the invention, in accordance with a second embodiment at the beginning of a welding procedure;

FIG. 3B—an enlarged section of part of FIG. 3A;

FIG. 4A—the device from FIG. 3A after the profiles surfaces have been heated up;

FIG. 4B—an enlargement of part of FIG. 4A;

FIG. 5A—a perspective schematic view of a section of a third embodiment of the invention, with a separate displacement element;

FIG. 5B—an enlargement of part of FIG. 5A;

FIG. 6A—the device from FIG. 5A after the profiles have been processed by means of the method according to the invention;

FIG. 6B—an enlargement of part of FIG. 6A;

FIG. 7A—a schematic top view of a preferred modification of the third embodiment of the invention;

FIG. 7B—an enlargement of part of FIG. 7A;

FIG. 8A—the modification according to FIG. 7A in a schematic perspective view;

FIG. 8B—an enlargement of part of FIG. 8A;

FIG. 9A—a schematic perspective view of a section of a device having a heating element according to the invention;

FIG. 9B—an enlargement of part of FIG. 9A;

FIG. 10A—a perspective schematic view of a section of a device having an alternative embodiment of the heating element according to the invention; and

FIG. 10B—an enlarged section of part of FIG. 10A.

### DETAILED DESCRIPTION OF EMBODIMENTS

For the sake of greater clarity, the same reference numerals are retained for the same or functionally identical components in all of the embodiments shown.

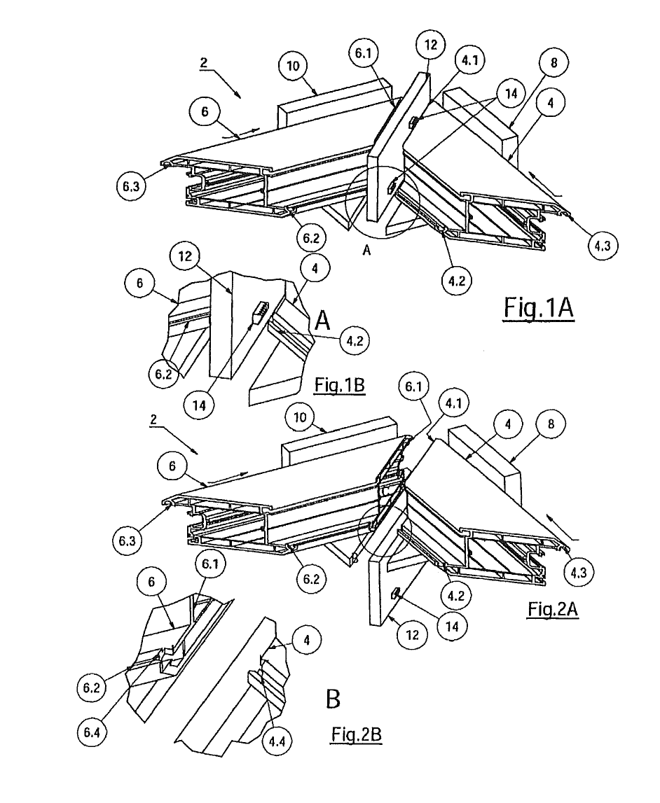

FIG. 1A shows a perspective view of a section of a device 2 according to the invention, in accordance with a first embodiment.

The device 2 serves to weld two plastic profile bars 4, 6 on their individual surfaces 4.1, 6.1 using a heat reflector or heating mirror not shown in this embodiment.

The plastic profile bars 4, 6 have gasket grooves 4.2, 4.3, 6.2, 6.3 into which a gasket has already been inserted ex factory. The gasket does not appear in the embodiments depicted below in order to illustrate the mode of operation of each device being shown, although the gaskets are present in the actual implementations.

The plastic profile bars 4, 6 are clamped in two schematically sketched clamping devices 8, 10 that can move the profiles 4, 6 towards each other at a right angle to such an extent that the corresponding profile surfaces 4.1, 6.1 come into contact with each other or are joined. A stop 12 is provided between the profile surfaces 4.1, 6.1 and it can be moved between these profile surfaces 4.1, 6.1, as can be seen in FIG. 2A.

The device 2 according to the invention now has displacement elements 14 on the surfaces of the stop 12 facing the profile surfaces 4.1, 6.1, said displacement elements 14 being arranged precisely in the area where the gasket grooves 4.2, 4.3, 6.2, 6.3 of the profiles 4, 6 make contact with the stop 12, as can be seen in FIG. 1B.

The profiles 4, 6 are moved towards each other until the profile surfaces 4.1, 6.1 come to lie essentially over the entire surface of the stop 12. When the profiles 4, 6 are positioned on the stop 12 along the directions indicated by the arrows, the profile surfaces 4.1, 6.1 first come into contact with the displacement elements 14 in the area of the gasket grooves 4.2, 4.3, 6.2, 6.3, after which plastic material in the area of the gasket grooves 4.2, 4.3, 6.2, 6.3 is mechanically displaced opposite to the direction of movement and laterally to the sectional plane of the profile surfaces 4.1, 6.1 at a depth and height of approximately 2 mm and at a length of approximately 6 mm.

After the material has been displaced into these areas, the profile surfaces 4.1, 6.1 of the profiles 4, 6 are moved further towards the stop 12, and the profile surfaces 4.1, 6.1 then reach the requisite contact position with the stop 12.

The stop 12 can be quickly replaced manually so that the device 2 can be adapted to different profiles. Different profiles have gaskets with different profile heights. Moreover, it is also possible for profiles without inserted gaskets to be processed on the same device, and, as is common practice in the state of the art, they can be welded together without material displacement. An automatic quick replacement is likewise possible.

In another embodiment not shown here, the displacement elements themselves can be quickly replaced since, for instance, they are configured so that they can be plugged in or slid into a groove, whereby the stop 12 then has a plurality of plug-in slots into which the displacement elements can be plugged in.

FIG. 1B shows the section A from FIG. 1A in an enlarged view for purposes of illustrating the positional relationship between the displacement element 14 and the gasket groove 4.2 of the profile 4.

The displacement element 14 in the embodiment shown is configured to be shaped like a comb, which simplifies the displacement of the plastic material. Shapes that are like a cube, like a cam or, as described in the following embodiment, like a wedge or a double wedge, have proven to be especially suitable as additional geometries for the displacement element 14.

FIG. 2A shows the device from FIG. 1A after the profile surfaces 4.1, 6.1 have been positioned. In this process, the stop 12 was removed from the space formed between the profile surfaces 4.1, 6.1.

In the enlarged view according to FIG. 2B, it can be seen that a setback 6.4 is formed in the area of the guide groove 6.2, while a setback 4.4 is formed in the area of the guide groove 4.2. When the profiles 4, 6 are pressed against each other, material can no longer spill over in the areas of the setbacks 4.4, 6.4, so that the gaskets are kept in the required position and do not spill over.

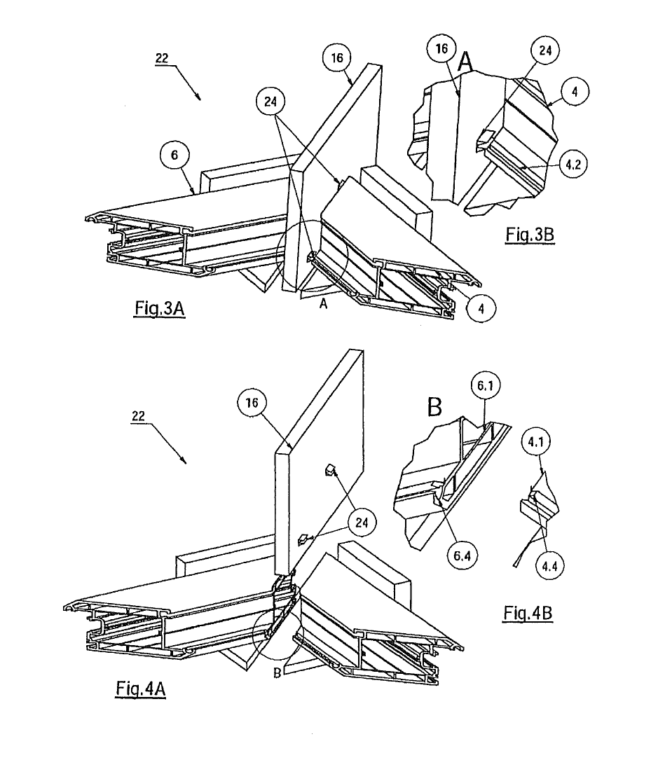

FIG. 3A shows a second embodiment of a device 22 according to the invention.

Between the profile surfaces 4.1, 6.1, there is a heating mirror 16 which, as shown in FIG. 4A, can be moved in between the profile surfaces 4.1, 6.1. The heat reflector or heating mirror 16 is heated up to a sufficiently high temperature, for instance, above 250° C. [482° F.], and its surface is coated with a heat-resistant non-stick material, so that the profile surfaces 4, 6 do not adhere to the heat reflector or heating mirror 16.

The device 22 according to the invention now has displacement elements 24 on the two surfaces of the heat reflector or heating mirror 16 facing the profile surfaces 4.1, 6.1, whereby, as can be seen in FIG. 1B, the displacement elements 24 are arranged precisely in the area where the gasket grooves 4.2, 4.3, 6.2, 6.3 of the profiles 4, 6 come into contact with the heat reflector or heating mirror 16. The displacement elements 24 are likewise heated by the heat reflector or heating mirror 16 and, when the profiles 4, 6 are positioned on the heating mirror 16 along the directions indicated by the arrows, the profile surfaces 4.1, 6.1 first come into contact with the heat reflector or heating mirror 16 in the area of the gasket grooves 4.2, 4.3, 6.2, 6.3. As a result, partially melted plastic material in the area of gasket grooves 4.2, 4.3, 6.2, 6.3 is displaced opposite to the direction of movement and laterally to the sectional plane of the profile surfaces 4.1, 6.1 at a depth of approximately 2 mm.

After the material has been displaced in these areas, the profile surfaces 4.1, 6.1 of the profiles 4, 6 are moved further towards the heat reflector or heating mirror 16, then said profile surfaces 4.1, 6.1 reach the contact position with the heat reflector or heating mirror 16 and are heated to a temperature above the melting temperature of the profile material.

The heat reflector or heating mirror 16 can be quickly replaced manually so that the device 22 can be adapted to different profiles. An automatic quick replacement is likewise possible. Different profiles have gaskets with different profile heights. Moreover, it is possible for profiles without inserted gaskets to be processed and, as is common practice in the state of the art, they can be welded together without material displacement.

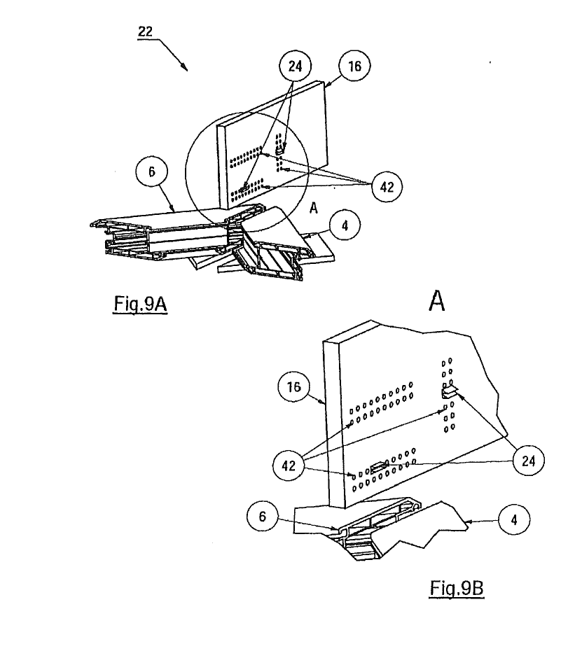

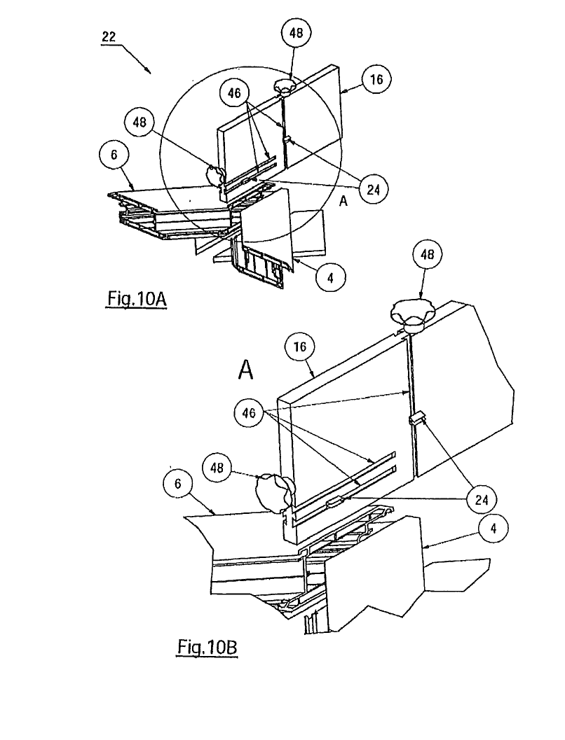

In another embodiment, as shown in FIGS. 9A to 10B, the displacement elements themselves can be quickly replaced, for instance, they are configured so that they can be plugged in or slid into a groove, whereby the heat reflector or heating mirror 16 then has a plurality of plug-in slots into which the displacement elements can be plugged in.

In the embodiment of the device 22 according to the invention shown in FIG. 3A, displacement elements 24 are provided on the heat reflector or heating mirror 16 and they each have a wedge-like shape in contrast to the first embodiment shown according to FIGS. 1A to 2B and, as can be seen in FIG. 3B, they displace the profile 4 in the area of the gasket groove 4.2 towards the back along a wedge-shaped trajectory.

In this context, the wedge-shaped displacement elements 24 are configured in such a way that they reach, at least partly, under the gaskets (not shown here), so that the gaskets are pushed towards the back during the material displacement.

In this context, the lower wedge is aligned relative to the profile in such a way that it comes to engage with the plastic profile, whereas the upper wedge pushes the gasket itself downwards so that the latter cannot be pushed out of its appertaining groove when the profile material is being displaced.

As shown in FIGS. 4A, 4B, this gives rise to setbacks 4,4′, 6,6′ that allow the profiles 4.1, 6.1 to be welded to each other in a defined manner.

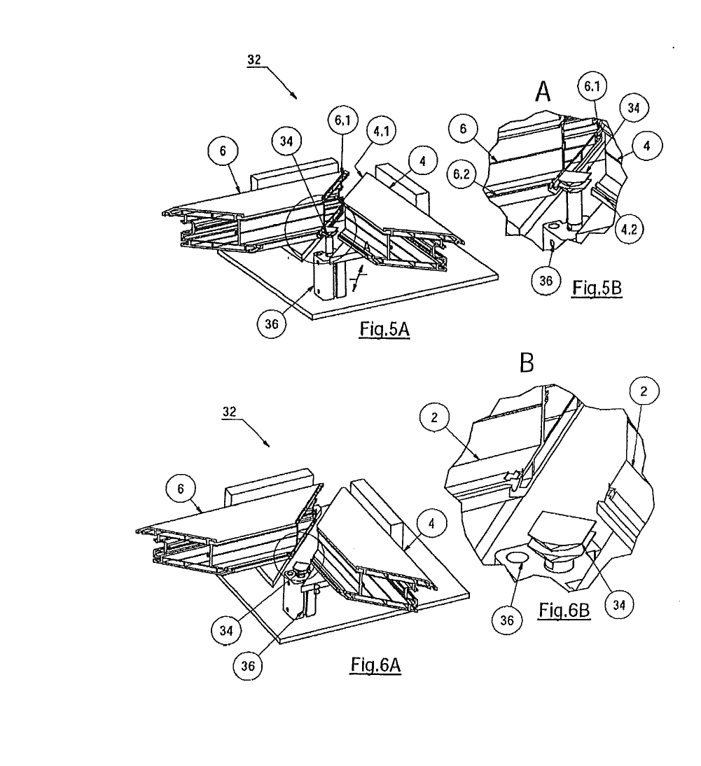

FIGS. 5A to 6B show a third embodiment of the invention. In the device 32 depicted there, no displacement elements are provided on a stop or on a heat reflector or heating mirror, but rather, a separate displacement element 34 is provided that can be moved by means of a positioning device 36 into the space formed by the profile surfaces 4.1, 6.1.

The displacement element 34 according to the third embodiment is likewise configured in a double-prismatic manner with respect to the areas that come into contact with the profiles 4, 6, as shown in the second embodiment, in order to attain a defined displacement of material of the plastic frames 4, 6, thus ensuring that the gaskets fit securely.

The displacement element 34 in the third embodiment is heated in order to convert the material to be displaced into the plastic state, so that it can then be displaced in an easier and more defined manner. As an alternative, however, it is also conceivable to have an unheated displacement element.

By means of the positioning device 36, the displacement element 34 is used in a work step prior to inserting the heat reflector or heating mirror (not shown here), thus requiring an additional work step. However, the advantage of the third embodiment of the invention is that the displacement element 34 can be easily moved into any desired position, provided that the positioning device 36 is configured so that it can be moved along the profile cross section. This is particularly advantageous if, as is common practice, frequently changing types of profiles are processed in which the gaskets are located in different places. The third embodiment also makes it possible to easily implement an automatic positioning of the displacement element 34, since sensor means can be provided with which the position of the gaskets can be detected automatically.

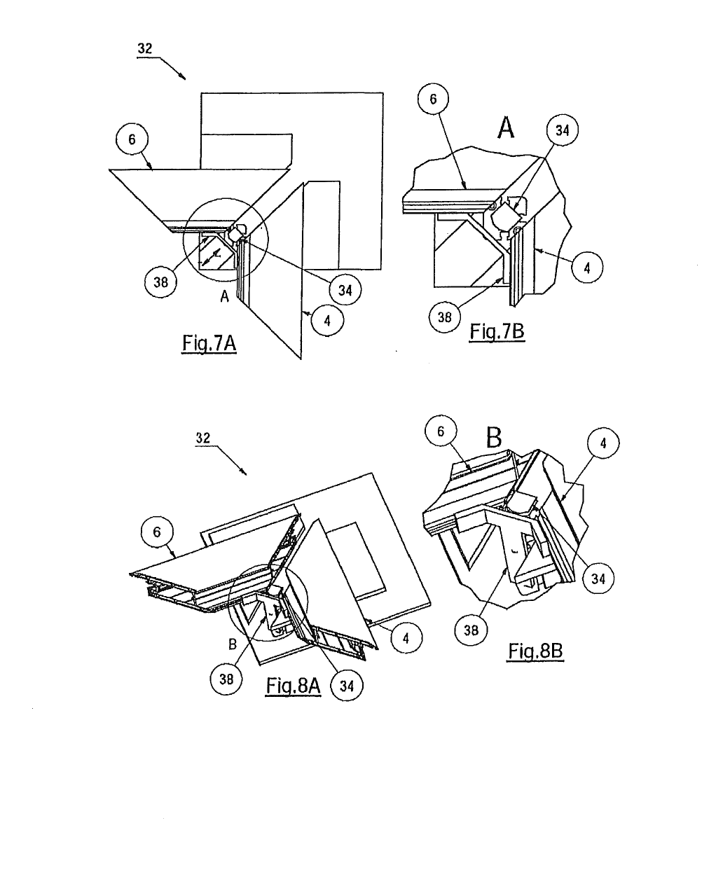

FIGS. 7A and 7B show a top view of the third embodiment of the device 32 having a displacement element 34 with an additionally provided positioning stop 38. This positioning stop 38 ensures an automatic positioning of the displacement element 34 on the profile bars 4, 6. Profiles made by a given manufacturer usually have standardized gasket positions relative to the outer edges of the profile bars. This allows the use of a positioning means that is passively controlled and that permits a precise positioning without additional programming or positioning effort involving the displacement element 34.

FIGS. 8A and 8B illustrate the embodiment of the positioning stop 38 in a perspective schematic view. The positioning stop is essentially T-shaped and has upper ends that are each at an angle of 45° relative to each other, so that these form contact surfaces with respect to the frame that are at an angle of 90° relative to each other. The above-mentioned angles have to be chosen differently in the case of profiles with special angles.

FIGS. 9A and 9B show a device 22 according to the invention in accordance with the second embodiment, comprising a heat reflector or heating mirror 16′ according to a first embodiment.

In order to allow the invention to be used for as many different profiles as possible, in a heat reflector or heating mirror 16 according to the invention, it is provided that the displacement elements 14 can be plugged into various plug-in positions. Towards this end, a perforated matrix 42 is provided that allows all types of familiar profiles to be processed by means of the method according to the invention. As an alternative, it is likewise possible for the stop 12 according to the first embodiment presented to be equipped with displacement elements that can be plugged in or that can be otherwise quickly replaced.

FIGS. 10A and 10B show another heating mirror 16″ according to the invention, which can be provided in a device 22 according to the invention. Here, the displacement elements 14 are configured in the form of dovetail guides 46 that can be adjusted by means of adjustment knobs 48. This accounts for an even more variable adaptation to the plastic profiles that are to be processed.

Additional embodiments can be created through combinations of the embodiments shown. For instance, it can be the case that a separate displacement element is provided together with a heating mirror having displacement elements, or else a stop is provided having at least one displacement element that has at least one heating mirror having at least one displacement element.

Furthermore, the displacement elements 14 as well as the stop 12, the heat reflector or heating mirror 16 and the like can all have a non-stick coating.

While preferred embodiments of the invention have been described and illustrated here, various changes, substitutions and modifications to the described embodiments will become apparent to those of ordinary skill in the art without thereby departing from the scope and spirit of the invention.

### LIST OF REFERENCE NUMERALS

2 device
4 first plastic profile piece
4.1 first profile surface
4.2, 4.3 gasket grooves of the first plastic profile piece
4.4, 4.4′ setback
6 second plastic profile piece
6.1 second profile surface
6.2, 6.3 gasket grooves of the second plastic profile piece
6.4, 6.4′ setback
8, 10 clamping devices
12 stop
14 displacement elements
16 heating mirror
22 device
24 displacement elements
32 device
34 displacement elements
36 positioning device
38 positioning stop
42 perforated matrix
46 dove-tail guides
48 adjustment knobs

1. A method for welding plastic profile bars that may be joined together to form a frame for a window or door that includes a gasket or seal, comprising:
displacing material of at least one of two profile bars in an area of at least one gasket positioned in said profile bar;
heating at least one of the two plastic profile bars on a surface to be fused or welded to a surface of the other plastic profile bar with a heating device; and
pressing the profile bars against each other in order to create a connection.

2. The method according to claim 1, characterized in that the material of the profile bar(s) that is to be displaced is partially melted prior to the displacement.

3. The method according to claim 1, characterized in that the material is displaced at a height and depth between about 1 mm and about 25 mm, and at a length of about 8 mm to about 15 mm.

4. The method according to claim 1, characterized in that the material is displaced with a displacement element having a prescribed profile shape selected from the group consisting of: a cube, a cam, a wedge, a double wedge, and a comb.

5. A device for welding plastic profile bars that may be joined together to form a frame for a window or door wherein one of both of such profile bars includes a gasket or seal, comprising:
at least one clamping device for clamping the profile bars,
at least one stop for aligning the profile bars in the device,
at least one heating device for heating at least one surface of at least one of the profile bars that are to be fused or welded together, and
at least one displacement element positioned so as to displace material of at least one of the profile bar(s) from an area holding or retaining the gasket or seal.

6. The device according to claim 5, characterized in that the displacement element(s) are configured as pressure pieces located on the stop.

7. The device according to claim 5, characterized in that the displacement element(s) are removable and interchangeable.

8. The device according to claim 5, characterized in that the displacement element(s) have a profile shape selected from the group consisting of: a cube, a cam, a wedge, a double wedge, and a comb.

9. The device according to claim 5, characterized in that the displacement element is movable by means of a positioning device parallel to a plane formed by a joining surface of one of the profile bars.

10. The device according to claim 5, characterized in that the displacement element is heated.

11. The device according to claim 5, characterized in that a positioning stop is associated with the displacement element.

12. The device according to claim 5, characterized in that at least one displacement element is provided in a position selected from the group consisting of: on a heating mirror, on a stop, and on a positioning stop.

13. The device according to claim 5, characterized in that a non-stick coating is applied to one or more components of the device selected from the group consisting of: the displacement element and the heating device.

14. The device according to claim 5, characterized in that the displacement element is arranged on the stop or on the heating device.

15. The device according to claim 5, characterized in that either the stop or the heating device has at least two parts that can be moved with respect to each other, and displacement elements are arranged on said moveable parts.

16. The method according to claim 1, wherein the material is displaced during the heating step.

17. The method according to claim 1, wherein the material is displaced after heating but prior to pressing the profile bars together.

18. The device according to claim 5, characterized in that the displacement element(s) are configured as pressure pieces located on the heating device.

19. The device according to claim 5, characterized in that the displacement element(s) are configured as pressure pieces located on a positioning device.
